(19) United States
(12) Patent Application Publication
(10) Pub. No.: US 2024/0410454 A1
(43) Pub. Date: Dec. 12, 2024

(54) HANDLING SYSTEM

(71) Applicant: Paolo BARBAGALLO, Prato (IT)

(72) Inventor: Paolo BARBAGALLO, Prato (IT)

(21) Appl. No.: 18/697,061

(22) PCT Filed: Aug. 1, 2022
(86) PCT No.: PCT/IB2022/057128

§ 371 Date: Mar. 29, 2024

(30) Foreign Application Priority Data
Oct. 8, 2021 (IT) 102021000025793

(51) Int. Cl. F16H 25/22

(52) U.S. Cl. CPC F16H 25/2204

(57) ABSTRACT

Described is a handling system, comprising a threaded bar, a nut configured to engage by screwing with said threaded bar and moving relative to said bar, said nut engaging with said bar by means of a plurality of spheres, said system comprising a plurality of skids for containing said spheres, said skids being positioned angularly distributed on said nut.

### TECHNICAL FIELD

This invention relates to a handling system.

In particular, the invention relates to a handling system of the type comprising a threaded bar and a nut engaged and movable on it.

### Background Art

These handling systems are usually used for moving a load from a surface to a higher surface, and vice versa.

Handling systems are used both in industrial and other contexts, for example residential, as in the case of elevators or lifts.

The prior art includes solutions which comprise the use of a mechanism comprising a threaded bar on which a recirculating ball screw nut is inserted.

Such a coupling is generally of the reversible type, that is to say, such that the nut slides along the axis of the worm screw mechanism, and such that, in order to descend, the nut does not need to be fed by transmission means, as it is possible to use the weight, that is, the force of gravity.

In the case of the elevator or lift, a recirculating ball screw nut allows the movement of the elevator/lift cabin both upwards and downwards, in a reversible fashion.

However, these couplings have drawbacks.

A major drawback is due to the fact that the nuts used in the prior art systems undergo elastic deformation during use due to working stresses under load.

The elastic deformations under load, in particular of the housing holding the nut, means that only some of the spheres contained in the nut support the nominal load planned for each of them, whilst the other spheres of the nut are subjected to progressively smaller loads.

Since this circumstance depends both on the elastic deformation of the materials with which the nut and the threaded bar are made, and on any manufacturing defects, it is not easily avoided without changing the construction architecture of the handling system as a whole or by increasing the level, and therefore the costs, of precision of the system.

### Aim of the Invention

The aim of the invention is therefore to provide a handling system which is able to overcome the above-mentioned drawbacks of the prior art.

A further aim of the invention is to provide a handling system in which it is possible to subject all the spheres of the nut to the nominal load, thereby optimising the overall number of spheres of the nut with the same load which can be supported by the handling system itself and providing a system which does not have an limit greater than the capacity of a nut.

A further aim of the invention is to provide a handling system which can use threaded bars obtained by rolling and not subjected to costly surface finishing.

A further aim of the invention is to provide a handling system which is at the same time practical to use and simple and inexpensive to make.

According to the invention, these aims and others are achieved by a handling system comprising the technical features described in the accompanying claims.

### BRIEF DESCRIPTION OF THE DRAWINGS

The technical features of the invention, with reference to the above-mentioned aims, are clearly described in the appended claims and its advantages are apparent from the detailed description which follows, with reference to the accompanying drawings which illustrate purely non-limiting example embodiments of the invention, in which:

FIG. 1 is a schematic perspective view of an embodiment of the handling system according to the invention;

FIG. 2 is a schematic top view partly in cross section of the handling system of FIG. 1;

FIG. 3 is a schematic bottom view partly cross section of a sphere-holder skid in accordance with the handling system according to the invention;

FIG. 4 is a schematic side view partly in cross section of the skid of FIG. 3 operatively connected to the threaded bar of the handling system according to this invention and

FIG. 5 is a top view in cross section of a skid according to the invention.

With reference to the accompanying drawings, the numeral 1 denotes in its entirety a handling system made in accordance with the invention, hereinafter also referred to simply as the system 1.

### DETAILED DESCRIPTION

Advantageously, the direction of movement is defined as vertical with respect to a horizontal plane or the ground but it is possible to use the handling system 1 according to the invention for moving loads in directions in any way inclined or parallel to a horizontal plane or the ground.

With reference to the accompanying drawings, the handling system 1 according to the invention comprises a threaded bar 2 having a main axis of extension A and a nut 3 configured to engage by screwing with the threaded bar 2.

The nut 3 is therefore able to move relative to the bar 2 along the axis A.

According to a first embodiment, the nut 3 moves axially following a rotation of the threaded bar 2, that is to say, it is the threaded bar 2 to be connected to a drive motor, not illustrated in the drawings.

According to a second embodiment, on the other hand, the bar 2 moves axially following a rotation of the nut 3, that is to say, the nut 3 is connected to a drive motor, not illustrated in the drawings.

The nut 3 engages with the threaded bar 2 by means of a plurality of spheres 4 which are designed to roll on the thread 9 of the bar 2.

The system 1 comprises a plurality of skids 5 for containing the spheres 4 which are positioned angularly distributed on the nut 3 and advantageously according to the inclination of the thread of the threaded bar 2 on which they engage.

As shown in FIG. 2, the skids are distributed in a radial fashion, which has as the centre the main axis of extension A of the threaded bar 2.

In this way it is possible to optimise the equal distribution of the load on each single skid 5 of the nut.

Advantageously, the nut 3 comprises a plurality of seats 6, which are also angularly distributed in a radial fashion, having as the centre the main axis of extension A of the threaded bar 2.

The seats 6 are designed to contain the skids 5.

Advantageously, both the skids 5 and the respective seats 6 are positioned angularly equally distributed on the nut 3.

In particular, each seat 6 corresponds to a respective skid 5 which, during operation of the handling system 1, is inserted and retained in the respective seat 6.

The skids 5 are held in the respective seats 6 by locking means, for example a threaded grub screw, not illustrated in the drawings.

Both the seats 6 and, therefore, the skids 5 are positioned in a plane substantially perpendicular to the main axis of extension A of the threaded bar 2.

The term substantially perpendicular means a plane which follows the inclination of the thread 9 of the threaded bar 2.

According to this embodiment, the seats 6 and the respective skids 5 are arranged in a spiral on the nut 3.

Advantageously, the skids 5 can be removed with respect to the respective seats 6, which allows, for example, maintenance operations to be performed quickly and easily by simply extracting one or more skids 5 from the respective seats 6.

Advantageously, moreover, the seats 6 have a cylindrical shape and the skids 5 have a portion shaped to match a respective seat 6 for allowing at least an oscillation of the skids 5 relative to the nut 3.

The above-mentioned oscillation is due to a rotation of the skids 5 with respect to the relative B.

The axis B is perpendicular to the main axis of extension A of the threaded bar 2.

The oscillation makes it possible to obtain an adjustment of the position of the skids 5, and in particular of the spheres 4 held inside them, with respect to the trend/inclination of the thread 9 of the bar 2.

The above-mentioned oscillation of each single skid 5 in the relative seat 6 allows automatic adaptation of the skid 5 to threaded bars 2 having different angles of inclination of the spiral (thread).

The advantage achieved is that a same skid 5 may be used on threaded bars 2 having different threads and/or different diameters.

The system 1 also comprises a deformable element 7 elastically interposed between the seats 6 and the respective skids 5.

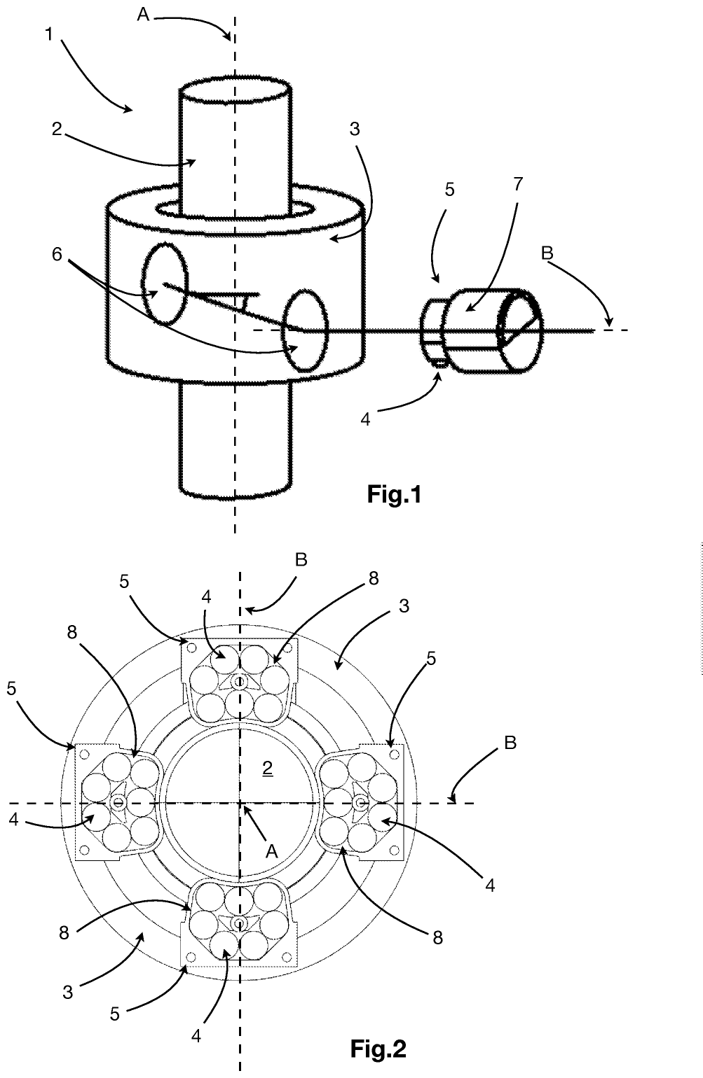

According to the embodiment shown in FIGS. 1 and 4 the elastically deformable element 7 is positioned integral with a portion of each of the skids 5.

Alternatively, or in addition, the deformable element 7 is positioned integral with an inner surface of each of the seats 6 (this embodiment is not shown in the drawings).

Both solutions allow an effect of suspension and damping of the movement of the single skid 5 with respect to the relative seat 6 to be obtained.

This damping makes it possible to overcome, for example, any manufacturing defects of the threaded bar 2, for example in the case of bars 2 made by rolling, or bars added to increase the length, or any elastic deformations of the bar, or of the nut 3, during operation.

The presence of a deformable element 7 for each single skid 5 makes it possible to obtain a secure distribution of the load to which the nut 3 is subjected equally distributed on all the skids 5 and, therefore, on all the spheres 4.

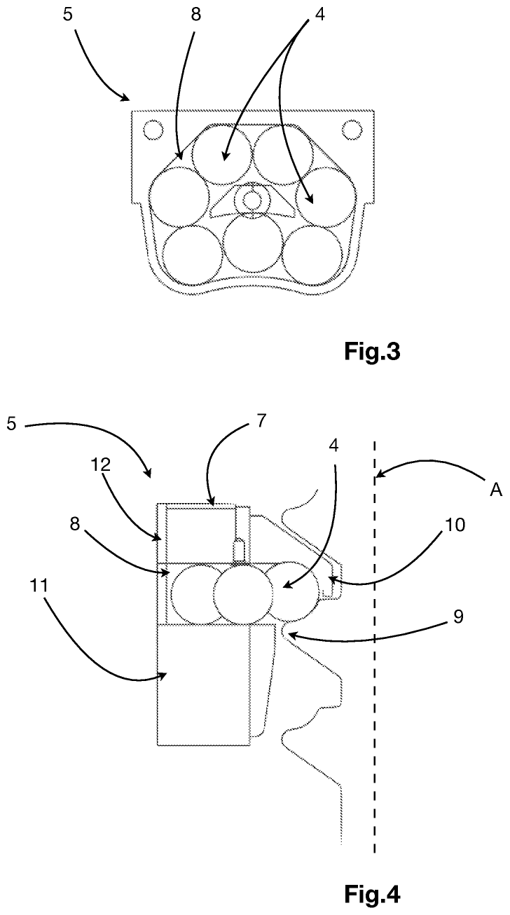

With reference to FIGS. 2, 3 and 4, each skid 5 comprises an internal channel 8 for housing and recirculating a plurality of the above-mentioned spheres 4.

For example, each skid 5 comprises seven spheres 4 of which, during operation, two always in contact with the portion of thread 9 of the bar 2.

The spheres 4 are designed to roll on the portion of thread 9 of the bar 2 and circulate inside the channel 8 of the respective skid.

This solution makes it possible to obtain an equal distribution of the loads on each single sphere 4 of a single skid 5 and, therefore, an equal “aging” of all the spheres 4 of a single skid 5.

Advantageously, as shown in FIG. 4, each skid 5 comprises a retaining unit 10 configured to prevent the escape of the spheres 4 from the channel 8 when the skid 5 is extracted from the respective seat 6.

The skids 5 may also, individually, be removed from the respective seats 6 even when the nut 3 is under load.

This makes it possible to easily perform maintenance operations on the individual skids 5 without having to remove the nut 3 from the threaded bar 2, which is an operation that would be very expensive since it would result in the stoppage of the entire handling system 1.

The skids 5 comprise two semi-portions which are joined to each other to form the body of the skid 5.

More in detail, the skid 5 comprises a lower portion 11 designed for centring with respect to the respective seat and an upper portion 12 designed to contain the recirculation channel 8 of the spheres 4. The two portions 11, 12 form a cylinder when coupled.

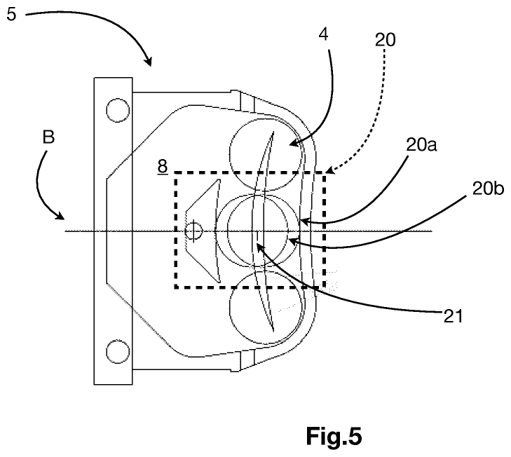

FIG. 5 shows a view from below in cross section of a skid 5 which indicates a loading portion 20 (dashed line) of the spheres 4 when they are in contact with the thread of the respective threaded bar 2 and transmit the load to it.

In particular, the shape of the recirculating channel 8 for the spheres 4 inside the skid 5 is such as to allow the spheres 4 under load, that is to say, those passing from the loading portion 20, and only them, to freely travel along reasonably different trajectories.

As shown in FIG. 5, the spheres 4 under load can be positioned, when inside the portion 20, in at least two positions 20a, 20b (and all the multiple intermediate positions) of the channel 8.

FIG. 5 also schematically illustrates a portion 21 which corresponds to the area where all the possible trajectories which can be followed by the spheres 4 of a single skid 5 lie.

Each trajectory travelled by the spheres 4 corresponds to a diameter of the threaded bar 2.

It is understood that when the diameter of the threaded bar 2 is varied, the diameter of the nut 3 which can be coupled with it also varies.

The advantage is that it is possible to use the same skid 5 with nuts 3 and respective threaded bars 2 having even very different diameters.

The handling system 1 according to the invention achieves the preset aims and brings further important advantages.

A first advantage of the handling system 1 according to the invention is the possibility of using threaded bars 2 obtained, for example, by rolling, which are more economical than those which are more finished and precise.

This is because each single skid 5 can be adapted to any imperfections of geometry of the threaded bar 2 and/or of the nut 3.

Another advantage of the handling system 1 according to invention is due to the fact that each skid 5 always uses only two spheres 4 loaded by the threaded bar 2 at their nominal load.

This means that all the pairs of spheres 4 of all the skids 5 are loaded at the relative nominal load, that is to say, they are used to their maximum potential.

Since, therefore, all the spheres 4 are loaded in an equal and optimum manner and since there is no partly loaded sphere, with the same load required of the handling system 1, this comprises an overall number of spheres 4 which are optimum, and not over-sized as in the prior art.

Another advantage of the handling system 1 according to the invention is due to the fact that, since each single skid 5 (and hence the relative spheres 4) is independent of the remaining skids 5 of the nut, each of them is able to adapt to the portion of thread of the threaded bar 2 which it touches without being influenced during operation by the remaining spheres 4 and/or skids 5 of the nut 3.

1. A handling system comprising:
a threaded bar having a main axis of extension,
a nut configured to engage by screwing with said threaded bar and moving relative to said bar along said axis, said nut engaging with said bar by means of a plurality of spheres, said system being characterised in that it comprises a plurality of skids for containing said spheres, said skids being positioned angularly on said nut, said nut comprising a plurality of seats angularly distributed on it and having a cylindrical shape; each of said skids having a portion shaped to match a respective of said seats to allow at least one oscillation relative to an axis of said skids with respect to said nut, said axis being perpendicular to said axis of said bar.

2. The system according to claim 1, wherein said skids are removable with respect to said seats.

3. The system according to claim 1, further comprising an elastically deformable element interposed between said seats and the respective said skids.

4. The system according to any one of the preceding claims, claim 1, wherein said deformable element is integral with one respective of said skids.

5. The system according to claim 3, wherein said deformable element is integral with an inner surface of each of said seats.

6. The system according to claim 1, wherein each of said skids comprises a housing and recirculating channel for housing and recirculating a plurality of said spheres.

7. The system according to claim 1, wherein each of said skids comprises a retaining member configured to prevent said spheres from escaping from said channel when said skid is extracted from said respective seat.

8. The system according to claim 1, wherein said nut moves as a result of a rotation of said threaded bar or vice versa said bar moves as a result of a rotation of said nut.
